(19) United States
(12) Patent Application Publication
(10) Pub. No.: US 2023/0262152 A1
(43) Pub. Date: Aug. 17, 2023

(54) MOBILE TERMINAL AND METHOD FOR ASSEMBLING MOBILE TERMINAL

(71) Applicant: JRD COMMUNICATION (SHENZHEN) LTD., Shenzhen (CN)

(72) Inventors: Yufan YANG, Shenzhen (CN); Yuansheng YU, Shenzhen (CN); Weihui FAN, Shenzhen (CN); Wei CHEN, Shenzhen (CN); Dongshui SU, Shenzhen (CN)

(73) Assignee: JRD COMMUNICATION (SHENZHEN) LTD., Shenzhen (CN)

(21) Appl. No.: 18/304,939

(22) Filed: Apr. 21, 2023

Related U.S. Application Data
(63) Continuation-in-part of application No. PCT/CN2020/134678, filed on Dec. 8, 2020.

(30) Foreign Application Priority Data
Oct. 22, 2020 (CN) 202011140765.7

(51) Int. Cl. H04M 1/02

(52) U.S. Cl. CPC H04M 1/0266; H04M 1/0283; H04M 2250/22

(57) ABSTRACT

A mobile terminal includes a front housing assembly, a display module, and a touch screen decoration part. The display module includes a display screen, a first adhesive layer, and a touch screen cover plate that is a 2.5D glass cover plate and has a thickness ranging from 0.7 mm to 3 mm. The touch screen decoration part is disposed around the display module and assembled with the display module into a three-in-one assembly.

### CROSS-REFERENCE TO RELATED APPLICATIONS

This application is a continuation of International Application No. PCT/CN2020/134678, filed on Dec. 8, 2020, which claims priority to and the benefit of Chinese Patent Application No. 202011140765.7, filed on Oct. 22, 2020. The disclosures of the aforementioned applications are incorporated herein by reference in their entireties.

### TECHNICAL FIELD

The present application relates to mobile terminals and methods for assembling a mobile terminal.

### BACKGROUND

A frame of a smartphone is designed to be narrower and narrower, so that the ratio of the screen viewable area to the front panel area of the smartphone becomes higher and higher. Moreover, the three-dimensional (3D) curved screen design becomes more and more popular. However, the of the 3D curved screen design generally uses a curved organic light-emitting diode (OLED) screen with a relatively high cost.

### SUMMARY

In view of the above, an embodiment of the present application provides a mobile terminal, including a front housing assembly, a display module, and a touch screen decoration part, where the front housing assembly includes a base plate and side walls extending from a periphery of the base plate to form a receiving space; the display module includes a display screen, a first adhesive layer, and a touch screen cover plate sequentially stacked, where the touch screen cover plate is a 2.5D glass cover plate and has a thickness ranging from 0.7 mm to 3 mm; the touch screen decoration part is disposed around the display module and assembled with the display module into a three-in-one assembly, where the three-in-one assembly is disposed in the receiving space.

Another embodiment of the present application provides a method for assembling a mobile terminal including steps of: providing a display screen and a touch screen cover plate, forming a first adhesive layer on a surface of the display screen, and bonding the touch screen cover plate to the display screen by the first adhesive layer to form a display module, wherein the touch screen cover plate is a 2.5D glass cover plate and has a thickness ranging from 0.7 mm to 3 mm; providing a touch screen decoration part, and forming with a dispenser a fourth adhesive layer and a fifth adhesive layer respectively on a first step surface and a second step surface of the touch screen decoration part, wherein the first step surface and the second step surface are symmetrical; bonding the display module to the first step surface and the second step surface of the touch screen decoration part respectively by the fourth adhesive layer and the fifth adhesive layer, to form a three-in-one assembly; performing first press-fit on the three-in-one assembly with a first press-fit machine; forming, by spraying adhesive, a second adhesive layer and a third adhesive layer respectively on a first side and a second side of a back surface of the three-in-one assembly subjected to the first press-fit, wherein the first side and the second side of the back surface are symmetrical; placing the three-in-one assembly with the second adhesive layer and the third adhesive layer into a first pressure holding box for pressure holding and fixing to obtain a fixed three-in-one assembly; providing a front housing assembly, and dispensing adhesive on a periphery of the front housing assembly with the dispenser; assembling the fixed three-in-one assembly with the front housing assembly having the adhesive on the periphery, to form a second assembly; and performing second press-fit on the second assembly with a second press-fit machine.

Yet another embodiment of the present application provides a mobile terminal, including a front housing component, a display module, and a touch screen decoration part; the front housing assembly includes a base plate and side walls extending from a periphery of the base plate to form a receiving space; the display module includes a display screen, a first adhesive layer, and a touch screen cover plate sequentially stacked, where the touch screen cover plate is a 2.5D glass cover plate and has a thickness ranging from 0.7 mm to 3 mm; the touch screen decoration part is disposed around the display module, and is assembled with the display module into a three-in-one assembly, where the three-in-one assembly is disposed in the receiving space; and a distance between a first side surface and a second side surface of the touch screen cover plate is greater than a distance between a first side surface and a second side surface of the display screen.

### BRIEF DESCRIPTION OF THE DRAWINGS

FIG. 1 is a schematic structural diagram of a mobile terminal according to an embodiment of the present application.

FIG. 2 is a schematic diagram of a three-in-one assembly of a mobile terminal according to an embodiment of the present application.

FIG. 3 is an exploded view of a mobile terminal according to an embodiment of the present application.

FIG. 4 is a flow diagram of a method for assembling a mobile terminal according to an embodiment of the present application.

### DETAILED DESCRIPTION

Some embodiments of the present application will be described below in conjunction with the drawings. The embodiments are described for illustration only, but not intended to limit the present application.

In the description of the present application, it should be understood that orientations or position relationships indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, and “counter-clockwise” are based on orientations or position relationships illustrated in the drawings. The terms are used to facilitate and simplify the description of the present application, rather than indicate or imply that the devices or elements referred to herein are required to have specific orientations or be constructed or operate in the specific orientations. Accordingly, the terms should not be construed as limiting the present application. In addition, the term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present application, the meaning of “plurality” is two or more, unless otherwise specifically defined.

In the description of the present application, it should be noted that the terms “installation”, “connection” and “coupling” should be understood in a broad sense, unless otherwise clearly specified and defined. For example, it can be a fixed connection, a detachable connection, or integrated connection; it can be a mechanical connection, an electrical connection or can communicate with each other; it can be directly connected or indirectly connected through an intermediary, it can also be the connection between two elements or the interaction between two elements. Those ordinary skilled in the art can understand the specific meanings of the above terms in the present application according to specific situations.

In the present application, it should he noted that unless otherwise clearly defined and limited, a first feature “on” or “under” a second feature may mean that the first feature directly contacts the second feature, or that the first feature contacts the second feature via an additional feature there between instead of directly contacting the second feature. Moreover, the first feature “on”, “above”, and “over” the second feature may mean that the first feature is right over or obliquely upward over the second feature or mean that the first feature has a horizontal height higher than that of the second feature. The first feature “under”, “below”, and “beneath” the second feature may mean that the first feature is right beneath or obliquely downward beneath the second feature or mean that horizontal height of the first feature is lower than that of the second feature.

The following description provides various embodiments or examples for implementing various structures of the present application. To simplify the description of the present application, parts and settings of specific examples are described as follows. Certainly, they are only illustrative, and are not intended to limit the present application. Further, reference numerals and reference letters may be repeated in different examples of the present application. This repetition is for purposes of simplicity and clarity and does not indicate a relationship of the various embodiments and/or the settings. Furthermore, the present application provides specific examples of various processes and materials, however, applications of other processes and/or other materials may be appreciated those skilled in the art.

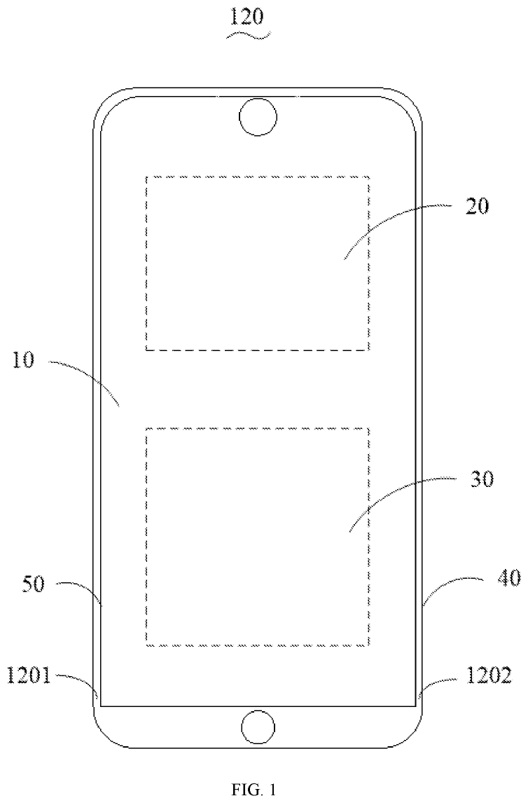

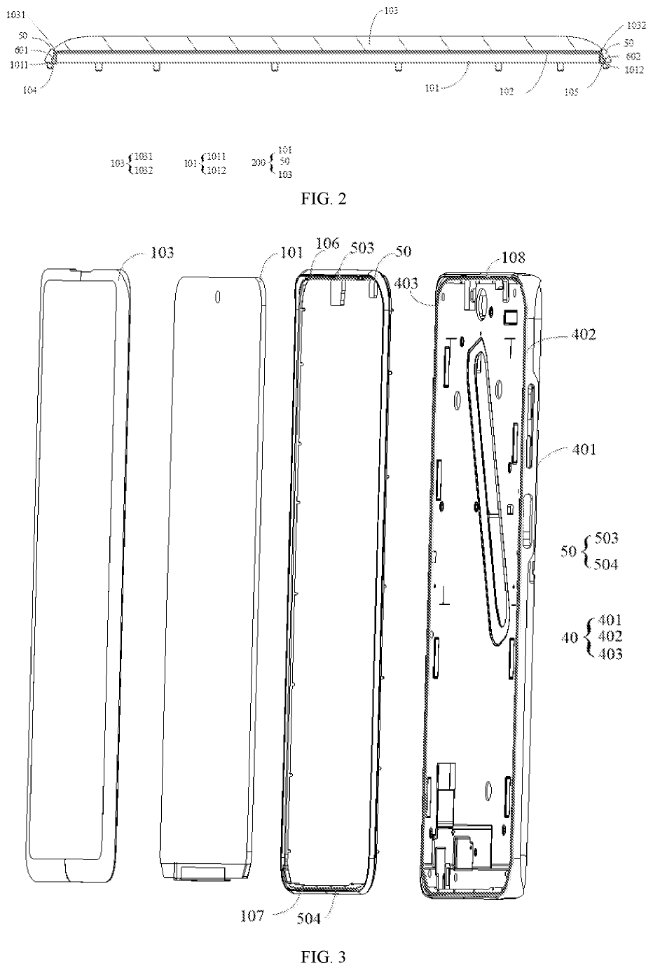

An embodiment of the present application provides a mobile terminal. The mobile terminal may be a smartphone, a tablet computer, a smart watch, or the like. Referring to FIGS. 1 to 3, the mobile terminal 120 includes a display module 10, a circuit board 20, a battery 30, a front housing assembly 40, and a touch screen decoration part 50.

The front housing assembly 40 includes a base plate 401 and side walls 402 extending from the periphery of the base plate to form a receiving space. The display module 10 includes a display screen 101, a first adhesive layer 102, and a touch screen cover plate 103, which are sequentially stacked, and the touch screen cover plate 103 is mounted on the display screen 101 to cover the display screen 101. The display screen 101 is a common liquid crystal display screen, and the touch screen cover plate 103 may be a transparent glass cover plate. For example, the touch screen cover plate 103 may be a glass cover plate made of a material such as sapphire. The touch screen cover plate 103 is a 2.5D glass cover plate and has a thickness ranging from 0.7 mm to 3 mm. For example, the touch screen cover plate 103 may have a thickness of 2 mm. For example, the touch screen cover plate 103 may be a 2.5D glass cover plate having a thickness of 2 mm, so that the touch screen cover plate 103 can be fully attached to a common liquid crystal display screen by a multi-pass fine carving and polishing process, thereby achieving the effect of the 3D curved screen and reducing the costs. In addition, the size of projection of either a left side or a right side of the touch screen cover plate 103 relative to corresponding single-side of the display screen 101 is in the range of 0 mm to 1 mm. For example, the size of projection of either the left side or the right side of the touch screen cover plate 103 relative to corresponding single-side of the display screen 101 is 0.25 mm. However, in the conventional narrow frame design on the market, the size of projection of either the left side or the right side of the touch screen cover plate 103 relative to corresponding single-side of the display screen 101 is 1 mm. Therefore, compared with the mobile terminal made of the touch screen cover plate of the conventional design, the mobile terminal 120 made of the touch screen cover plate 103 implements reduction of the size of a black edge at the single-side, which is in the range of 0 mm to 1 mm, thereby realizing the ultra-narrow frame design.

The display screen 101 is mounted on the front housing assembly 40 to form a display surface of the mobile terminal 120. The display screen 101 may include a display region and a non-display region. The display region is configured to display information such as an image and text. The non-display region does not display information. Functional components such as a fingerprint module, a touch circuit, and the like may be provided at the bottom of the non-display region.

For example, the display screen 101 may further be a full screen, with only the display region and without the non-display region. The functional components such as the fingerprint module and the touch circuit are disposed under the full screen. For example, the display screen 101 may further be a special-shaped screen.

The front housing assembly 40 may form an outer contour of the mobile terminal 120. The touch screen cover plate 103 is attached to the touch screen decoration part 50, and is fixed to the front housing assembly 40 along with the touch screen decoration part 50. The touch screen cover plate 103, the touch screen decoration part 50, and the front housing assembly 40 are configured to form a closed space to accommodate devices such as the display screen 101, the circuit board 20, the battery 30, and the first adhesive layer 102.

In some embodiments, the front housing assembly 40 may be made of metallic materials such as magnesium alloy, stainless steel, or the like. It should be noted that the material of the front housing assembly 40 according to the embodiment of the present application is not limited thereto, and other means may be employed. For example, the front housing assembly 40 may include a non-metallic portion and a metallic portion. For example, the front housing assembly 40 may also be a plastic housing. For example, the front housing assembly 40 may also be a ceramic housing. For example, the front housing assembly 40 may also be a housing structure in which a metal material is combined with a plastic material. The front housing assembly 40 may be manufactured by cold processing, hot processing, injection molding, extrusion molding, compression molding, blow molding, casting molding, and gas-assisted molding. For example, when the material of the front housing assembly 40 is aluminum or an aluminum alloy, the front housing assembly 40 may be manufactured by cold processing such as turning, milling, planning, drilling, drawing, or the like. For example, when the material of the front housing assembly 40 is a non-metallic material, the front housing assembly 40 may be manufactured by a non-metallic material molding such as injection molding.

The printed circuit board 20 is mounted in the front housing assembly 40. The printed circuit board 20 may be a main board of the mobile terminal 120, which is an important element for providing electrical connection for each electronic component in the mobile terminal 120. The printed circuit board 20 may be divided into a single panel, a double panel, a four-layer board, a six-layer board, and other multi-layer circuit board according to the number of circuit board layers. The printed circuit board 20 generally includes a base material, a metal coating, and a circuit layer. The printed circuit board 20 may be integrated with one, two, or more of functional components such as a motor, a microphone, a speaker, a headset interface, a universal serial bus interface, a camera, a distance sensor, an ambient light sensor, a telephone receiver, a processor, a radio frequency module, and the like.

The battery 30 is mounted in the front housing assembly 40 and electrically connected to the printed circuit board 20 to supply power to the mobile terminal 120.

In some embodiments, a distance between a first side surface 1031 and a second side surface 1032 of the touch screen cover plate 103 is greater than a distance between a first side surface 1011 and a second side surface 1012 of the display screen 101. That is, the touch screen cover plate 103 can cover the display screen 101.

In some embodiments, the first side surface 1031 of the touch screen cover plate 103 and the first side surface 1011 of the display screen 101 are located on a first side 1021 of the mobile terminal 120, the second side surface 1032 of the touch screen cover plate 103 and the second side surface 1012 of the display screen 101 are located on a second side 1202 of the mobile terminal 120, a first distance between the first side surface 1031 of the touch screen cover plate 103 and the first side surface 1011 of the display screen 101 is equal to a second distance between a second side surface 1032 of the touch screen cover plate 103 and a second side surface 1012 of the display screen 101, and either of the first distance and the second distance ranges from 0 mm to 1 mm.

In the conventional narrow frame design on the market, the size of projection of either the left side or the right side of the touch screen cover plate relative to corresponding single-side of the display screen is about 1 mm. However, in the narrow frame design of the present application, the size of projection of either a left side (i.e., the first side surface 1031) or a right side (i.e., the second side surface 1032) of the touch screen cover plate 103 relative to either a left side (i.e., the first side surface 1011) or a right side (i.e., the second side surface 1012) of the display screen 101 is in the range of 0 mm to 1 mm (which may be 0.25 mm, for example). Therefore, compared with the mobile terminal made of the touch screen cover plate of the conventional design, the mobile terminal 120 made of the touch screen cover plate 103 implements reduction of the size of a black edge at the single-side, which is in the range of 0 mm to 1 mm, thereby realizing the ultra-narrow frame design.

In some embodiments, a first gap 601 is formed between the first side surface 1011 of the display screen 101 and a first side surface 501 of the touch screen decoration part 50, a second gap 602 is formed between the second side surface 1012 of the display screen 101 and a second side surface 502 of the touch screen decoration part 50, a second adhesive layer 104 and a third adhesive layer 105 are respectively provided in the first gap 601 and the second gap 602, and the display screen 101 is attached to the touch screen decoration part 50 by the second adhesive layer 104 and the third adhesive layer 105.

By means of the second adhesive layer 104 and the third adhesive layer 105, the first side surface 1011 of the display screen 101 is tightly attached to the first side surface 501 of the touch screen decoration part 50, and the second side surface 1012 of the display screen 101 is tightly attached to the second side surface 502 of the touch screen decoration part 50, so that the display screen 101 can be fixedly attached to the touch screen decoration part 50, and the first gap 601 and the second gap 602 can be filled up to prevent water, dust, and the like from entering the interior of the mobile terminal 120.

In some embodiments, an upper end and a lower end of the touch screen decoration part 50 have a first step surface 503 and a second step surface 504 respectively, and the touch screen cover plate 103 is bonded to the first step surface 503 and the second step surface 504 by a fourth adhesive layer 106 and a fifth adhesive layer 107, respectively.

The touch screen cover plate 103 is attached to the touch screen decoration part 50 with the fourth adhesive layer 106 and the fifth adhesive layer 107, and the touch screen cover plate 103 is attached to the display screen 101 with the first adhesive layer 102, thereby constituting a three-in-one assembly 200 including the touch screen cover plate 103, the display screen 101 and the touch screen decoration part 50.

In some embodiments, the front housing assembly 40 further includes an adhesive surface 403, where the three-in-one assembly 200 is attached to the adhesive surface 403 by a sixth adhesive layer 108.

The touch screen decoration part 50 in the three-in-one assembly 200 is attached to the adhesive surface 403 of the front housing assembly 40 with the sixth adhesive layer 108.

In some embodiments, each of the second adhesive layer 104, the third adhesive layer 105, the fourth adhesive layer 106, the fifth adhesive layer 107, and the sixth adhesive layer 108 comprises hot-melt adhesive.

The hot-melt adhesives are plastic adhesives, of which physical state changes with temperature over a range of temperatures, while chemical properties thereof do not change. The adhesive strength of the hot-melt adhesives is greater than that of the general adhesive, and a curing effect thereof is better. The thickness of the hot-melt adhesives can be more easily controlled, and the design requirement of the narrow frame of the electronic device can be more satisfied. In addition, the hot-melt adhesives are thermoplastic polyurethanes and products bonded using the hot-melt adhesives are easier to disassemble or repair. For example, the hot-melt adhesives may be Polyurethane Reactive (PUR) hot-melt adhesives, i.e., moisture-curable reactive polyurethane hot-melt adhesives, main components of which are isocyanate-terminated polyurethane prepolymers. The PUR hot-melt adhesives may be adjustable in terms of adhesion and toughness (elasticity), and has excellent adhesion strength, temperature resistance, chemical corrosion resistance, and aging resistance.

In some embodiments, the first adhesive layer 102, the fourth adhesive layer 106, the fifth adhesive layer 107, and the sixth adhesive layer 108 are formed by dispensing adhesive, and the second adhesive layer 104 and the third adhesive layer 105 are formed by spraying adhesive.

Since the second adhesive layer 104 and the third adhesive layer 105 are located in the first gap 601 and the second gap 602, and the sizes of the first gap 601 and the second gap 602 are so small that dispensing adhesive is inconvenient and cannot be dispensed to all positions, the second adhesive layer 104 and the third adhesive layer 105 are formed by spraying adhesive.

In some embodiments, the first adhesive layer 102 is an optical adhesive.

Since the optical adhesive is used as the first adhesive layer 102 for properties of the optical adhesive, not only can the touch screen cover plate 103 be fixedly connected to the display screen 101, but also the perspective effect of the display module 10 is not affected.

In some embodiments, the touch screen cover plate 103 has a thickness of 2 mm. The touch screen cover plate 103 has a curved surface effect that is closer to the 3D curved surface effect under the thickness, and the user has better grip feeling and experience.

In some embodiments, the touch screen cover plate 103 is manufactured by a fine carving and polishing process. The fine carving, i.e., a Computer Numerical Control (CNC), is configured to process the glass into a shape required for a project, i.e., processing the glass into a shape of the touch screen cover plate 103 of the present application. The main significance of polishing is to improve color of the appearance of the glass processed with CNC. The polishing process used in the touch screen cover plate 103 is a flat polishing process (which is mainly used to process a large plane), that is, the flat polishing process is used to increase an arc surface of the touch screen cover plate 103. In addition, since the thickness of the common 2.5D glass cover plate is only about 0.7 mm, the curvature of the common 2.5D glass cover plate can only be made small. In the present application, the thickness of the glass cover plate is thickened, so that the curvature of the 2.5D touch screen cover plate 103 can be increased to form a large curved surface effect. Finally, the present application has no requirement of the thickness of the LCD display screen, and the thickness of the LCD display screen does not affect the overall curved surface effect. Therefore, the touch screen cover plate 103 is subjected to a multi-pass fine carving and polishing process, and is then fully adhered to the common liquid crystal display screen, which can obtain the effect of the 3D curved surface screen and reduce the costs compared with a case in which a curved surface organic light-emitting diode (OLED, also referred to as organic electroluminescence display, or organic light emitting semiconductor) screen is used as the 3D curved surface screen.

In summary, the mobile terminal 120 provided in the embodiments of the present application includes the front housing assembly 40, the display module 10, and the touch screen decoration part 50; the front housing assembly 40 includes the base plate 401 and the side walls 402 extending from the periphery of the base plate 401 to form the receiving space; the display module 10 includes the display screen 101, the first adhesive layer 102, and the touch screen cover plate 103 sequentially stacked, where the touch screen cover plate 103 is the 2.5D glass cover plate and has a thickness ranging from 0.7 mm to 3 mm; and the touch screen decoration part 50 is disposed around the display module 10, and is assembled with the display module 10 into the three-in-one assembly 200, where the three-in-one assembly 200 is disposed in the receiving space. By using the 2.5D glass cover plate with a certain thickness and a certain size as the touch screen cover plate of the mobile terminal 120, performing a multi-pass fine carving and polishing process on the touch screen cover plate and then fully attaching the cover plate to the common liquid crystal display screen according to embodiments of the present application, the effect of the 3D curved screen can be achieved, and the ultra-narrow frame design can be realized, thereby reducing the costs.

An embodiment of the present application further provides a method for assembling a mobile terminal, which is applied to the mobile terminal. The mobile terminal may be a smartphone, a tablet computer or the like.

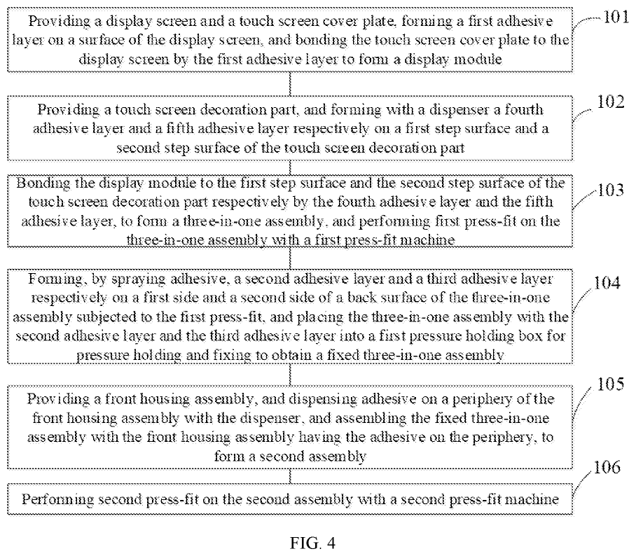

FIG. 4 is a flow diagram of a method for assembling a mobile terminal according to an embodiment of the present application. The method for assembling the mobile terminal, which is applied to the mobile terminal, can include: providing a display screen and a touch screen cover plate, forming a first adhesive layer on a surface of the display screen, and bonding the touch screen cover plate to the display screen by the first adhesive layer to form a display module, where the touch screen cover plate is a 2.5D glass cover plate and has a thickness ranging from 0.7 mm to 3 mm; providing a touch screen decoration part, and forming with a dispenser a fourth adhesive layer and a fifth adhesive layer respectively on a first step surface and a second step surface of the touch screen decoration part, wherein the first step surface and the second step surface are symmetrical; bonding the display module to the first step surface and the second step surface of the touch screen decoration part respectively by the fourth adhesive layer and the fifth adhesive layer, to form a three-in-one assembly; performing first press-fit on the three-in-one assembly with a first press-fit machine; forming, by spraying adhesive, a second adhesive layer and a third adhesive layer respectively on a first side and a second side of a back surface of the three-in-one assembly subjected to the first press-fit, wherein the first side and the second side of the back surface are symmetrical; placing the three-in-one assembly with the second adhesive layer and the third adhesive layer into a first pressure holding box for pressure holding and fixing to obtain a fixed three-in-one assembly; providing a front housing assembly, and dispensing adhesive on a periphery of the front housing assembly with the dispenser; assembling the fixed three-in-one assembly with the front housing assembly having the adhesive on the periphery, to form a second assembly; and performing second press-fit on the second assembly with a second press-fit machine.

Step 101 of providing a display screen and a touch screen cover plate, forming a first adhesive layer on a surface of the display screen, and bonding the touch screen cover plate to the display screen by the first adhesive layer to form a display module, where the touch screen cover plate is a 2.5D glass cover plate and has a thickness ranging from 0.7 mm to 3 mm.

The first adhesive layer is an optical adhesive. Since the optical adhesive is used as the first adhesive layer for properties of the optical adhesive, not only can the touch screen cover plate be fixedly connected to the display screen, but also the perspective effect of the display module is not affected.

Step 102 of providing a touch screen decoration part, and forming with a dispenser a fourth adhesive layer and a fifth adhesive layer respectively on a first step surface and a second step surface of the touch screen decoration part, wherein the first step surface and the second step surface are symmetrical.

Before the symmetrical first and second step surfaces in the touch screen decoration part are dispensed by the dispenser, the adhesive required for dispensing is preheated to a specified temperature, and then the preheated adhesive is loaded into a heating cylinder of the dispenser and continuously heated. The temperature is controlled from 110° C. to 120° C., thereby ensuring that the adhesive is in a molten state and facilitating the dispensing of the adhesive by the dispenser. A dispensing needle is installed in the dispenser. The preheating temperature of the adhesive is from 110° C. to 120° C. and the preheating time of the adhesive is from 10 minutes to 20 minutes.

Step 103 of bonding the display module to the first step surface and the second step surface of the touch screen decoration part respectively by the fourth adhesive layer and the fifth adhesive layer, to form a three-in-one assembly, and performing first press-fit on the three-in-one assembly with a first press-fit machine.

The adhesives may be selected from at least one of 003AC, 002AC, 004AC, and 003B from MeiXin, 3579 and 3605 from LeTai, and 7852B from HuiTian, because these adhesives are all heating-type adhesive, stable in adhesive performance, strong in adhesive force, and easy to disassemble. On the one hand, the display module and the touch screen decoration part can be fixedly attached, and on the other hand, the display module can be reused after disassembling if the display module and the touch screen decoration part are to be repaired. The time range of the first press-fit is 7 seconds to 10 seconds, and a press-fit force of the first press-fit is 0.2 MPa to 0.4 MPa.

In some embodiments, the bonding of the display module to the first step surface and the second step surface includes: fitting the display module to the touch screen decoration part, so that a first end of the display module is bonded to the first step surface by the fourth adhesive layer and a second end of the display module is bonded to the second step surface by the fifth adhesive layer.

Step 104 of forming, by spraying adhesive, a second adhesive layer and a third adhesive layer respectively on a first side and a second side of a back surface of the three-in-one assembly subjected to the first press-fit, wherein the first side and the second side of the back surface are symmetrical, and placing the three-in-one assembly with the second adhesive layer and the third adhesive layer into a first pressure holding box for pressure holding and fixing to obtain a fixed three-in-one assembly.

The three-in-one assembly is placed into the first pressure holding box for pressure holding and fixing so as to prevent the three-in-one assembly from being formed yet and affect the next operation.

In some embodiments, the forming of the second adhesive layer and the third adhesive layer comprises includes: putting the three-in-one assembly into a positioning fixture; spraying with a first sprayer the adhesive on the first side and the second side of the back surface of the put three-in-one assembly; taking the sprayed three-in-one assembly out of the positioning fixture; and re-spraying with a second sprayer the adhesive on the first side and the second side of the back surface of the taken three-in-one assembly to form the second adhesive layer and the third adhesive layer.

The adhesive is re-sprayed on the three-in-one assembly because no adhesive is sprayed on the position clamped by the positioning fixture when the adhesive is sprayed first, and therefore, the adhesive is resprayed on the position.

Step 105 of providing a front housing assembly, and dispensing adhesive on a periphery of the front housing assembly with the dispenser, and assembling the fixed three-in-one assembly with the front housing assembly having the adhesive on the periphery, to form a second assembly.

Step 106 of performing second press-fit on the second assembly with a second press-fit machine.

The time range of the second press-fit is 7 seconds to 10 seconds, and a press-fit force of the second press-fit is 0.2 MPa to 0.4 MPa.

In some embodiments, after performing first press-fit on the three-in-one assembly, the method further includes: putting the three-in-one assembly subjected to the first press-fit into the first pressure holding box for first pressure holding and fixing.

The time for first pressure holding and fixing is two hours.

In some embodiments, after performing second press-fit on the second assembly, the method further includes: putting the second assembly subjected to the second press-fit into a second pressure holding box for second pressure holding and fixing.

The time for second pressure holding and fixing is two hours.

As can be seen from the above, the method for assembling the mobile terminal provided according to the embodiments of the present application provides the display screen and the touch screen cover plate, and applies the layer of adhesive to the lower surface of the display screen to form the first adhesive layer, and attaches the touch screen cover plate to the display screen with the first adhesive layer to form the display module, where the touch screen cover plate is the 2.5D glass cover plate and has the thickness ranging from 0.7 mm to 3 mm; provides the touch screen decoration part, and dispenses the first step surface and the second step surface which are symmetrical in the touch screen decoration part with the dispenser to form the fourth adhesive layer and the fifth adhesive layer, so that the first step surface and the second step surface of the touch screen decoration part are adhered with the adhesive; bonds the display module to the first step surface and the second step surface of the touch screen decoration part with the adhesive to form the three-in-one assembly and perform first press-fit on the three-in-one assembly with the first press-fit machine; sprays adhesive on the first side and the second side of opposite back surfaces of the three-in-one assembly that are symmetrical to form the second adhesive layer and the third adhesive layer and place the three-in-one assembly into the first pressure holding box for pressure holding and fixing; provides the front housing assembly, dispenses the periphery of the front housing assembly with the dispenser, and assembles the three-in-one assembly that is placed into the first pressure holding box for pressure holding and fixing with the front housing assembly which is dispensed with the dispenser; and performing second press-fit on the assembled three-in-one assembly and front housing assembly with the second press-fit machine. According to the embodiments of the present application, the design of the ultra-narrow frame of the mobile terminal is realized through the two-pass dispensing plus the two-pass adhesive spraying process.

Some embodiments of the present application have been described above, but not intended to limit the scope of the present application. Any variations, equivalent substitutions, modifications and the like within the spirit and principles of the present application are intended to fall within the scope of the present application.

What is claimed is:

1. A mobile terminal, comprising a front housing assembly, a display module, and a touch screen decoration part,
wherein the front housing assembly comprises a base plate and side walls extending from a periphery of the base plate to form a receiving space;
the display module comprises a display screen, a first adhesive layer, and a touch screen cover plate that are sequentially stacked, wherein the touch screen cover plate is a 2.5D glass cover plate and has a thickness ranging from 0.7 mm to 3 mm; and
the touch screen decoration part is disposed around the display module and assembled with the display module into a three-in-one assembly, wherein the three-in-one assembly is disposed in the receiving space.

2. The mobile terminal of claim 1, wherein a distance between a first side surface and a second side surface of the touch screen cover plate is greater than a distance between a first side surface and a second side surface of the display screen.

3. The mobile terminal of claim 2, wherein
the first side surface of the touch screen cover plate and the first side surface of the display screen are located on a first side of the mobile terminal;
the second side surface of the touch screen cover plate and the second side surface of the display screen are located on a second side of the mobile terminal;
a first distance between the first side surface of the touch screen cover plate and the first side surface of the display screen is equal to a second distance between the second side surface of the touch screen cover plate and the second side surface of the display screen; and
each of the first distance and the second distance ranges from 0 mm to 1 mm.

4. The mobile terminal of claim 2, wherein
a first gap is formed between the first side surface of the display screen and a first side surface of the touch screen decoration part;
a second gap is formed between the second side surface of the display screen and a second side surface of the touch screen decoration part; and
a second adhesive layer and a third adhesive layer are provided respectively in the first gap and the second gap, and the display screen is bonded to the touch screen decoration part by the second adhesive layer and the third adhesive layer.

5. The mobile terminal of claim 4, wherein an upper end and a lower end of the touch screen decoration part have a first step surface and a second step surface respectively, and the touch screen cover plate is bonded to the first step surface and the second step surface by a fourth adhesive layer and a fifth adhesive layer, respectively.

6. The mobile terminal of claim 5, wherein the front housing assembly has an adhesive surface, and the three-in-one assembly is bonded to the adhesive surface by a sixth adhesive layer.

7. The mobile terminal of claim 6, wherein each of the second adhesive layer, the third adhesive layer, the fourth adhesive layer, the fifth adhesive layer, and the sixth adhesive layer comprises hot-melt adhesive.

8. The mobile terminal of claim 6, wherein the first adhesive layer, the fourth adhesive layer, the fifth adhesive layer, and the sixth adhesive layer are formed by dispensing adhesive, and the second adhesive layer and the third adhesive layer are formed by spraying adhesive.

9. The mobile terminal of claim 1, wherein the first adhesive layer comprises optical adhesive.

10. The mobile terminal of claim 1, wherein the touch screen cover plate has a thickness of 2 mm.

11. A method for assembling a mobile terminal, comprising:
providing a display screen and a touch screen cover plate, forming a first adhesive layer on a surface of the display screen, and bonding the touch screen cover plate to the display screen by the first adhesive layer to form a display module, wherein the touch screen cover plate is a 2.5D glass cover plate and has a thickness ranging from 0.7 mm to 3 mm;
providing a touch screen decoration part, and forming with a dispenser a fourth adhesive layer and a fifth adhesive layer respectively on a first step surface and a second step surface of the touch screen decoration part, wherein the first step surface and the second step surface are symmetrical;
bonding the display module to the first step surface and the second step surface of the touch screen decoration part respectively by the fourth adhesive layer and the fifth adhesive layer, to form a three-in-one assembly;
performing first press-fit on the three-in-one assembly with a first press-fit machine;
forming, by spraying adhesive, a second adhesive layer and a third adhesive layer respectively on a first side and a second side of a back surface of the three-in-one assembly subjected to the first press-fit, wherein the first side and the second side of the back surface are symmetrical;
placing the three-in-one assembly with the second adhesive layer and the third adhesive layer into a first pressure holding box for pressure holding and fixing to obtain a fixed three-in-one assembly;
providing a front housing assembly, and dispensing adhesive on a periphery of the front housing assembly with the dispenser;
assembling the fixed three-in-one assembly with the front housing assembly having the adhesive on the periphery, to form a second assembly; and
performing second press-fit on the second assembly with a second press-fit machine.

12. The method of claim 11, wherein the bonding of the display module to the first step surface and the second step surface comprises:
fitting the display module to the touch screen decoration part, so that a first end of the display module is bonded to the first step surface by the fourth adhesive layer and a second end of the display module is bonded to the second step surface by the fifth adhesive layer.

13. The method of claim 11, wherein the forming of the second adhesive layer and the third adhesive layer comprises:
putting the three-in-one assembly into a positioning fixture;
spraying with a first sprayer the adhesive on the first side and the second side of the back surface of the put three-in-one assembly;
taking the sprayed three-in-one assembly out of the positioning fixture; and
re-spraying with a second sprayer the adhesive on the first side and the second side of the back surface of the taken three-in-one assembly to form the second adhesive layer and the third adhesive layer.

14. The method of claim 11, further comprising: after performing the first press-fit on the three-in-one assembly,
putting the three-in-one assembly subjected to the first press-fit into the first pressure holding box for first pressure holding and fixing.

15. The method of claim 14, further comprising: after performing the second press-fit on the second assembly,
putting the second assembly subjected to the second press-fit into a second pressure holding box for second pressure holding and fixing.

16. A mobile terminal, comprising a front housing assembly, a display module, and a touch screen decoration part,
wherein the front housing assembly comprises a base plate and side walls extending from a periphery of the base plate to form a receiving space;
the display module comprises a display screen, a first adhesive layer, and a touch screen cover plate that are sequentially stacked, wherein the touch screen cover plate is a 2.5D glass cover plate and has a thickness ranging from 0.7 mm to 3 mm;
the touch screen decoration part is disposed around the display module and assembled with the display module into a three-in-one assembly, wherein the three-in-one assembly is disposed in the receiving space; and
a distance between a first side surface and a second side surface of the touch screen cover plate is greater than a distance between a first side surface and a second side surface of the display screen.

17. The mobile terminal of claim 16, wherein the touch screen cover plate has a thickness of 2 mm.

18. The mobile terminal of claim 16, wherein
the first side surface of the touch screen cover plate and the first side surface of the display screen are located on a first side of the mobile terminal;
the second side surface of the touch screen cover plate and the second side surface of the display screen are located on a second side of the mobile terminal;
a first distance between the first side surface of the touch screen cover plate and the first side surface of the display screen is equal to a second distance between the second side surface of the touch screen cover plate and the second side surface of the display screen; and
each of the first distance and the second distance ranges from 0 mm to 1 mm.

19. The mobile terminal of claim 18, wherein
a first gap is formed between the first side surface of the display screen and a first side surface of the touch screen decoration part;
a second gap is formed between the second side surface of the display screen and a second side surface of the touch screen decoration part; and
a second adhesive layer and a third adhesive layer are provided respectively in the first gap and the second gap, and the display screen is bonded to the touch screen decoration part by the second adhesive layer and the third adhesive layer.

20. The mobile terminal of claim 19, wherein an upper end and a lower end of the touch screen decoration part has a first step surface and a second step surface respectively, and the touch screen cover plate is bonded to the first step surface and the second step surface by a fourth adhesive layer and a fifth adhesive layer, respectively.
